(19) United States
(12) Patent Application Publication
(10) Pub. No.: US 2026/0058933 A1
(43) Pub. Date: Feb. 26, 2026

(54) EVALUATING FILES USING A RULE- OR FEATURE-BASED SYSTEM FOR DETECTION OF MALICIOUS AND/OR SUSPICIOUS PATTERNS

(71) Applicant: STAIRWELL, INC., Mountain View, CA (US)

(72) Inventor: Michael Joseph WIACEK, Santa Clara, CA (US)

(21) Appl. No.: 19/105,865

(22) PCT Filed: Aug. 7, 2023
(86) PCT No.: PCT/US2023/029658

§ 371 Date: Feb. 24, 2025

Related U.S. Application Data
(60) Provisional application No. 63/401,468, filed on Aug. 26, 2022.

(51) Int. Cl. H04L 9/40

(52) U.S. Cl. CPC H04L 63/0245; H04L 63/1425

(57) ABSTRACT

A method for evaluating rules for detecting malicious files in a network repository is provided. The method includes receiving, in the network repository, files from file sources to create a corpus of files, wherein the network repository is separated by a firewall from the file sources, scanning each file against a character string of a first rule in the rule list for detecting a malicious pattern to determine if one or more files satisfy the first rule. Based on the scanning, the method includes counting a number of files that satisfy the first rule, determining a score for the first rule based on the number of files that satisfy the first rule, and ranking the first rule in the rule list based on the score. A system including a processor and a memory storing instructions to cause the system to perform the above method is also provided.

### TECHNICAL FIELD

The present disclosure generally relates to evaluating electronic file security. More particularly, the present disclosure relates to evaluating files against character strings (e.g., character strings of a rule- or feature-based system for detecting malicious and/or suspicious patterns) to identify malicious and/or suspicious code.

### BACKGROUND

Organizations that accept file uploads to their platforms (e.g., file hosting services) run the risk of accepting files containing malicious and/or suspicious code (e.g., Trojans, viruses, etc.). As users of the platforms share files amongst one another, the risk of propagating a malware-infected file only makes the issue more pressing. As such, such organizations typically create a file security evaluation system to protect themselves, and their customers, from this threat.

### BRIEF SUMMARY

The subject disclosure provides for systems and methods for evaluating files using a rule- or feature-based system for detecting malicious and/or suspicious patterns to, for instance, identify malicious and/or suspicious code, or to identify files having characteristics of interest that may warrant further evaluation. One or more files (and/or file copies) may be received and scanned against a character string of a rule- or feature-based system for detecting malicious and/or suspicious patterns to determine a likelihood that the file(s)/file copy(ies) contain malicious and/or suspicious code or one or more other characteristics of interest. In aspects, file(s)/file copy(ies) may be received from a plurality of sources to create a corpus of files. Based on the scanning, a numeric count of a number of files that matches character strings of the rule- or feature-based system for detecting malicious and/or suspicious patterns may be caused to be displayed. In aspects, an efficacy of the character string may be determined based, at least in part, on the number of files of the corpus of files that matches the character string. In aspects, the character string may be labeled with a characteristic based, at least in part, on the number of files of the corpus of files that matches the character string.

In a first embodiment, a computer-implemented method for evaluating rules in a rule list for detecting malicious files in a network repository includes receiving, in a network repository, one or more files from each of a plurality of file sources to create a corpus of files, wherein the network repository is separated by a firewall from the file sources, scanning each file of the corpus of files against a character string of a first rule in the rule list for detecting a malicious pattern to determine if one or more files of the corpus of files satisfy the first rule. Based on the scanning, the computer-implemented method also includes causing a numeric count of a number of files of the corpus of files that satisfy the first rule to be displayed, determining a score for the first rule based, at least in part, on the number of files of the corpus of files that satisfy the first rule, and ranking the first rule in the rule list based on the score for the first rule.

In a second embodiment, a system configured for evaluating rules in a rule list for detecting malicious files in a network repository, includes one or more hardware processors configured by machine-readable instructions to perform a process. The process includes to: receive, in a network repository, one or more files from each of a plurality of file sources to create a corpus of files, wherein the network repository is separated by a firewall from the file sources, scan each file of the corpus of files against a character string of a first rule in the rule list for detecting a malicious pattern to determine if one or more files of the corpus of files satisfies the first rule, cause a numeric count of a number of files of the corpus of files that satisfies the first rule to be displayed, determine a score for the first rule based, at least in part, on the number of files of the corpus of files that satisfy the first rule, and label the first rule in the rule list with the score.

In a third embodiment, a non-transitory, computer-readable medium, stores instructions which, when executed by a processor in a computer, cause the computer to perform a method, including to: receive, in a network repository, one or more files from each of a plurality of file sources to create a corpus of files, wherein the network repository is separated by a firewall from the file sources, scan each file of the corpus of files against a character string of a first rule in a rule list for detecting a malicious pattern to determine if one or more files of the corpus of files satisfy the first rule, cause a numeric count of a number of files of the corpus of files that satisfy the first rule to be displayed, determine a score for the first rule based, at least in part, on the number of files of the corpus of files that satisfy the first rule, rank the first rule in the rule list based on the score for the first rule, and remove the first rule from the rule list when a score is lower than a selected threshold.

In yet another embodiment, a system includes a first means to store instructions and a second means to execute the instructions and cause the system to perform a method. The method includes receiving, in a network repository, one or more files from each of a plurality of file sources to create a corpus of files, wherein the network repository is separated by a firewall from the file sources, scanning each file of the corpus of files against a character string of a first rule in the rule list for detecting a malicious pattern to determine if one or more files of the corpus of files satisfy the first rule, based on the scanning, causing a numeric count of a number of files of the corpus of files that satisfy the first rule to be displayed, determining a score for the first rule based, at least in part, on the number of files of the corpus of files that satisfy the first rule, and ranking the first rule in the rule list based on the score for the first rule.

These and other embodiments will be evident to one of ordinary skills in the art, in view of the following.

### BRIEF DESCRIPTION OF THE DRAWINGS

To easily identify the discussion of any particular element or act, the most significant digit or digits in a reference number refer to the figure number in which that element is first introduced.

FIG. 1 illustrates an exemplary network architecture for implementing systems and methods consistent with the present disclosure, according to some embodiments.

FIG. 2 illustrates an exemplary screen display showing a number of files from each of a plurality of file groups that matches a YARA rule, in accordance with one or more implementations of the present disclosure.

FIG. 3 illustrates a system configured for evaluating files using a rule- or feature-based system for detecting malicious and/or suspicious patterns, in accordance with one or more implementations of the present disclosure.

FIG. 4 illustrates an exemplary flow diagram for evaluating files using a rule- or feature-based system for detecting malicious and/or suspicious patterns, in accordance with one or more implementations of the present disclosure.

FIG. 5 illustrates another exemplary flow diagram for evaluating files against character strings of a rule- or feature-based system for detecting malicious and/or suspicious patterns, in accordance with one or more implementations of the present disclosure.

FIG. 6 illustrates another exemplary flow diagram for evaluating rules in a rule list for detecting malicious files in a network repository, in accordance with one or more implementations of the present disclosure.

FIG. 7 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Organizations that accept file uploads to their platforms (e.g., file hosting services) run the risk of accepting files containing malicious and/or suspicious code (e.g., Trojans, viruses, etc.). As users of the platforms share files amongst one another, the risk of propagating a malware-infected file only makes the issue more pressing. As such, such organizations typically create a file security evaluation system to protect themselves, and their customers, from this threat. However, these file evaluation systems typically run on each computer or workstation, separately. Accordingly, when a suspicious file is detected or even a virus is identified, the problem is resolved locally, while the source may be remotely located and affect computers within an entire local area network or node. In addition to this, in some situations the virus or malware changes or deletes the affected file upon identifying detection by a local scanning system. In this case, the local scanning system may be fooled into believing that the problem is resolved, whereas the problem persists in other files residing in other computers (within the same network or not). In some embodiments, a localized scan may not find a suspicious file because the file may have been deleted by the virus itself prior to the scanning. Another problem of localized scanning is that it slows down the operation of each localized computer or workstation. Moreover, in some circumstances, a localized scan may be using a defective rule, but without a large sampling size, it may not be possible to detect such defect in the rule simply because only a limited number of files have been found within one computer or workstation.

To have a global scope of the dimension of a problem with infected or suspicious files, it is desirable to identify the origin of any of the multiple such files over a wide network of computers and workstations. In addition to this, it is desirable to have a global assessment of the quality of the rules used to identify suspicious files and malicious code, to optimize the efficiency of a virus scanning software on a global scale. For example, some virus scanning protocols may involve heavy computational resources and expenses, and therefore it may be desirable to devote these types of scans for a reduced number of files that have been identified by well-established and certified rules to be highly suspicious. Having a tiered set of rules based on the level of confidence that a suspicious assessment is issued may substantially improve the efficiency of a global scanning system and its cost-effectiveness.

To overcome the above shortcomings, embodiments as disclosed herein collect multiple files from multiple computers and locations in a secure repository that is remote to the local computers and workstations. Accordingly, file scanning is performed in the secured repository, independently from the localized system where the potential virus resides. This prevents a virus damaging the files in the local computer or workstation from reacting to the scanning and taking a pre-emptive action to avoid detection or removal. In addition, to avoid the above pitfalls of localized virus detection, a global scanning system as disclosed herein provides aggregated data about scanning rules that may indicate which rules may have obvious problems. For example, certain scanning rules may identify an excessive large number of files in violation of the rule. Such finding may indicate that the rule is ill-defined, or that an obvious error in the rule is resulting in regular files being flagged erroneously.

In accordance with aspects of the subject disclosure, systems and methods in file security evaluation are provided for evaluating files using a rule- or feature-based system for detecting malicious and/or suspicious patterns (e.g., YARA rules) to, for instance, identify malicious and/or suspicious code, or to identify files having characteristics of interest that may warrant further evaluation. As one example of such a rule-based system for detecting malicious and/or suspicious patterns. YARA is an open-source computing language that provides a way of identifying malware (or other files) by creating rules that look for certain characteristics. Utilizing YARA, a user writes a recipe or rule and evaluates suspicious files (or any files) against it to determine if the file matches the rule. Files matching rules then may be considered malicious (or at least suspicious). A feature-based system for detecting malicious and/or suspicious patterns is a system where features extract or derive information from a file to be used to search for other files that have those exact or similar features.

In accordance with aspects of the present disclosure, one or more files (and/or file copies) may be received and scanned against a character string of a rule- or feature-based system for detecting malicious and/or suspicious patterns to determine a likelihood that the file(s)/file copy(ies) contain malicious and/or suspicious code or one or more other characteristics of interest. In aspects, file(s)/file copy(ies) may be received from a plurality of sources to create a corpus of files.

### Example System Architecture

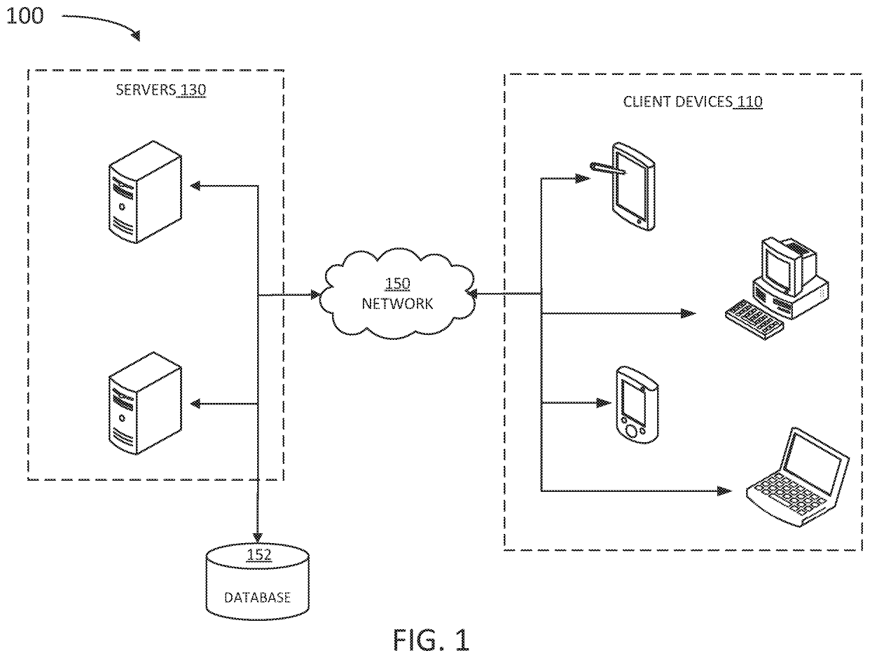

FIG. 1 illustrates an exemplary network architecture 100 for implementing systems and methods consistent with the present disclosure. Network architecture 100 includes one or more servers 130, at least one database 152, and multiple client devices 110, all the above communicatively coupled with one another via a network 150.

Servers 130 may provide a network service to users or customers handling client devices 110. Accordingly, client devices 110 may include mobile computing devices such as mobile phones, smartphones, palm/pad devices, or laptops, a desktop computer, or a workstation. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

By virtue of the interaction between servers 130, database 152, and client devices 110, multiple files are exchanged between storage locations and memory circuits in each of the above devices and systems. Some of these files may be contaminated with malicious code at the point of origin, with client devices 110, before they are uploaded to a server 130 or database 152. Some of these files may become corrupted locally, in database 152 over time or during transit there, or may be vulnerable to attack by a malicious third party with access to network 150. For example, in some circumstances, a server 130 (e.g., a node in network 150) may become rogue or controlled by a malicious agent or malware. Accordingly, a malicious workstation 110, or a network node or server 130 may become a source of malware, or pernicious software. To stop spreading malware throughout network 150, methods as disclosed herein act quickly to identify files of interest, and also the source of these files. Once a malicious node or server 130, or a workstation 110 is identified, it may be quarantined, put out of circulation, or a firewall may be built around it in network 150 while a repair or corrective measure is taken. Eventually, the server 130 or workstation 110 may be allowed to rejoin network 150 once a number of files generated therein are devoid of suspicious features, wherein the number is greater than a pre-selected threshold.

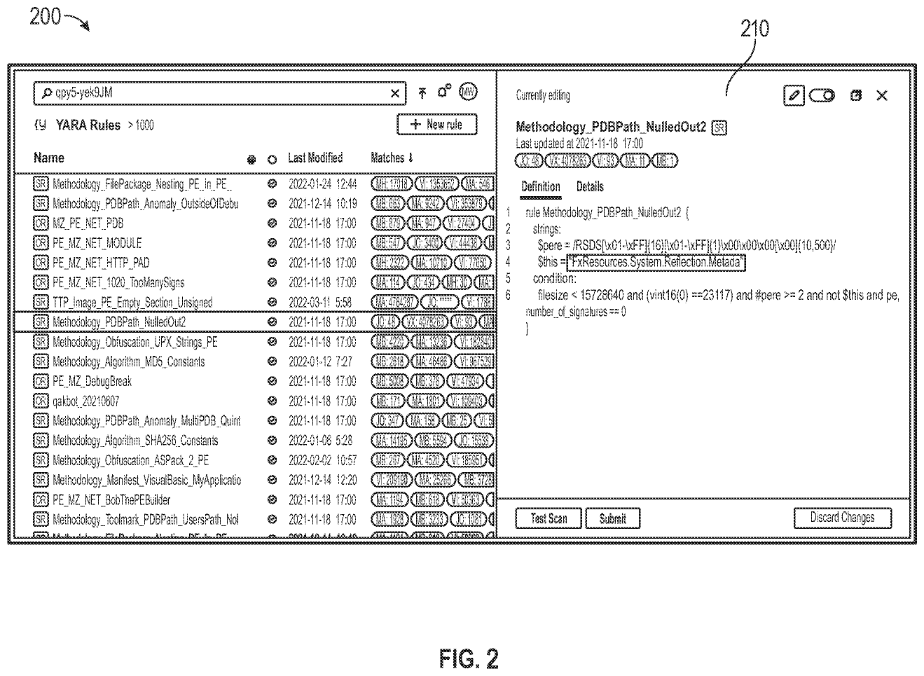

FIG. 2 illustrates an exemplary screen display 200 showing a rule 210 on the right-hand side that two contains strings. Rule 210 is identified as “Methodology_PDBPath_NulledOut2” and defines two strings. One string is called “pcre,” and is defined as “FxResources.System. Reflection.Metadata”. The second string is called “this” which is defined as a pattern that starts with RSDS and then has 16 characters in the range of [x01-xFF], followed by any one character from the range [x01-xFF], followed by three zero bytes, followed by any one zero byte character that occurs between ten and five hundred times. Rule 210 also has a condition that specifies to match this rule, the file has to be smaller than about 50 megabytes, the 16 bits at the start of the file must be 23117, the “pcre” pattern must occur two or more times and not contain the string “this” and the file must not be signed. Based on the scanning, a numeric count of a number of files that matches rule 210 may be caused to be displayed.

The numeric count of the number of files may be divided among different groups of environments from which the files were sourced. As shown, the numeric count of files matching rule 210 in the environment/group identified as “JC” is 48, the numeric count of files matching rule 210 in the environment/group identified as “VX” is 4,078,263, the numeric count of files matching rule 210 in the environment/group identified as “VI” is 93, the numeric count of files matching rule 210 in the environment/group identified as “MA” is 11, and the numeric count of files matching rule 210 in the environment/group identified as “MB” is 1.

In aspects, an efficacy of the rules may be determined based, at least in part, on the numeric count of files of the corpus of files and/or environments/groups within the corpus of files that matches the rules. In aspects, the rules may be labeled with a characteristic based, at least in part, on the numeric count of files of the corpus of files and/or environments/groups within the corpus of files that matches the rules. For example, for rule 210, the fact that in one environment an exceedingly large number of files has been found (e.g., VX with over 4 million files), may be an indication that the rule is not well defined and is not sufficiently discriminatory of a suspicious file. Such situation may arise because of a simple syntaxis error in the rule itself, and a review may be desirable before trusting a ruling stemming from this rule.

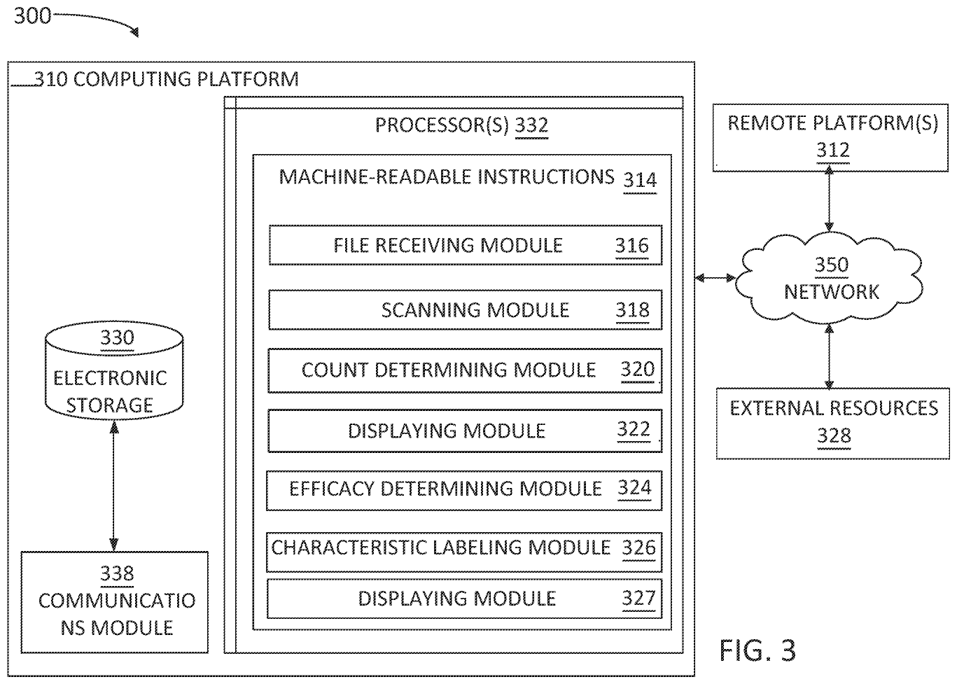

FIG. 3 illustrates a system 300 configured to evaluate files against character strings of a rule- or feature-based system for detecting malicious and/or suspicious patterns or rules, according to certain aspects of the present disclosure. In some implementations, system 300 may include one or more computing platforms 310. Computing platform(s) 310 may be configured to communicate with one or more remote platforms 312 according to a client/server architecture, a peer-to-peer architecture, and/or other architectures. Remote platform(s) 312 may be configured to communicate with other remote platforms via computing platform(s) 310 and/or according to a client/server architecture, a peer-to-peer architecture, and/or other architectures. Users may access system 300 via remote platform(s) 312.

Computing platform(s) 310 may be configured by machine-readable instructions 314. Machine-readable instructions 314 may include one or more instruction modules. The instruction modules may include computer program modules. The instruction modules may include one or more of file receiving module 316, scanning module 318, count determining module 320, displaying module 322, efficacy determining module 324, and characteristic labeling module 326.

File receiving module 316 may be configured to receive one or more files from each of a plurality of file sources to create a corpus of files. In aspects, file receiving module 316 may be configured to divide the corpus of files into a plurality of file groups. In aspects, file receiving module 316 may be configured to divide the corpus of files into a plurality of file groups that is coincident with the plurality of file sources. In aspects where the corpus of files has been scanned against a character string of a rule- or feature-based system for detecting malicious and/or suspicious patterns or rules, file receiving module 316 may be configured to receive one or more additional files into the corpus of files.

Scanning module 318 may be configured to scan each file of the corpus of files against a character string of a rule- or feature-based system for detecting malicious and/or suspicious patterns to determine if one or more files of the corpus of files matches the character string. In aspects where the corpus of files has been scanned against a character string of a rule- or feature-based system for detecting malicious and/or suspicious patterns and one or more additional files has been received into the corpus of files (e.g., by file receiving module 316), scanning module 318 may be configured to scan the one or more additional files against the character string (e.g., the YARA rule).

Count determining module 320 may be configured to determine a numeric count of files of the corpus of files that matches the character string. In aspects where the corpus of files is divided into a plurality of file groups, count determining module 320 may be configured to include a numeric count for at least a portion of the plurality of file groups that includes files within each respective file group that match the character string. In aspects where it is determined (e.g., by scanning module 318) that one or more additional files received into the corpus of files matches the character string, count determining module 320 may be configured to update the numeric count of files of the corpus of files and/or the numeric count of one or more file groups comprising the corpus of files.

Displaying module 322 may be configured to cause the numeric count of the number of files of the corpus of files that matches the character string to be displayed. In aspects where the corpus of files is divided into a plurality of file groups, displaying module 322 may be configured to cause display of a numeric count for at least a portion of the plurality of file groups that includes files within each respective file group that match the character string. In aspects where the numeric count has been updated (e.g., by the count determining module 320), displaying module 322 may be configured to display the updated numeric count of files of the corpus of files and/or the numeric count of one or more file groups comprising the corpus of files.

Efficacy determining module 324 may be configured to determine the efficacy of the character string based, at least in part, on the number of files of the corpus of files that matches the character string. In aspects, a number, percentage, ratio, or the like against which a number of files that match the character string may be compared to determine efficacy of the character string may be predetermined and/or configurable by a user.

Characteristic labeling module 326 may be configured to label the character string with a characteristic based on the number of files of the corpus of files that matches the character string. In aspects, the nature and quantity of characteristics that may be labeled may be configurable by a user.

In some implementations, computing platform(s) 310, remote platform(s) 312, and/or external resources 328 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 310, remote platform(s) 312, and/or external resources 328 may be operatively linked via some other communication media.

A given remote platform 312 may include one or more processors configured to execute computer program modules. The computer program modules may be configured to enable an expert or user associated with the given remote platform 312 to interface with system 300 and/or external resources 328, and/or provide other functionality attributed herein to remote platform(s) 312. By way of non-limiting example, a given remote platform 312 and/or a given computing platform 310 may include one or more of a server, a desktop computer, a laptop computer, a handheld computer, a tablet computing platform, a NetBook, a Smartphone, a gaming console, and/or other computing platforms.

External resources 328 may include sources of information outside of system 300, external entities participating with system 300, and/or other resources. In some implementations, some or all of the functionality attributed herein to external resources 328 may be provided by resources included in system 300.

Computing platform(s) 310 may include electronic storage 330, one or more processors 332, and/or other components. Computing platform(s) 310 may include communication lines, or ports to enable the exchange of information with a network and/or other computing platforms. Illustration of computing platform(s) 310 in FIG. 3 is not intended to be limiting. Computing platform(s) 310 may include a plurality of hardware, software, and/or firmware components operating together to provide the functionality attributed herein to computing platform(s) 310. For example, computing platform(s) 310 may be implemented by a cloud of computing platforms operating together as computing platform(s) 310.

Electronic storage 330 may comprise non-transitory storage media that electronically stores information. The electronic storage media of electronic storage 330 may include one or both of system storage that is provided integrally (i.e., substantially non-removable) with computing platform(s) 310 and/or removable storage that is removably connectable to computing platform(s) 310 via, for example, a port (e.g., a USB port, a firewire port, etc.) or a drive (e.g., a disk drive, etc.). Electronic storage 330 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 330 may include one or more virtual storage resources (e.g., cloud storage, a virtual private network, and/or other virtual storage resources). Electronic storage 330 may store software algorithms, information determined by processor(s) 332, information received from computing platform(s) 310, information received from remote platform(s) 312, and/or other information that enables computing platform(s) 310 to function as described herein.

In some implementations, computing platform(s) 310, remote platform(s) 312, and/or external resources 328 may be operatively linked via one or more electronic communication links, through a communications module 338. Communications module 338 is configured to interface with network 350 to send and receive information, such as data, requests, responses, and commands to other devices via network 350. Communications module 338 can be, for example, modems or Ethernet cards. Computing platform 310 may be a desktop computer, a mobile computer (e.g., a laptop, a palm device, a tablet, or a smart phone), or an AR/VR headset configured to provide an immersive reality experience to a user.

Processor(s) 332 may be configured to provide information processing capabilities in computing platform(s) 310. As such, processor(s) 332 may include one or more of a digital processor, an analog processor, a digital circuit designed to process information, an analog circuit designed to process information, a state machine, and/or other mechanisms for electronically processing information. Although processor(s) 332 is shown in FIG. 3 as a single entity, this is for illustrative purposes only. In some implementations, processor(s) 332 may include a plurality of processing units. These processing units may be physically located within the same device, or processor(s) 332 may represent processing functionality of a plurality of devices operating in coordination. Processor(s) 332 may be configured to execute modules 316, 318, 320, 322, 324, 326, and/or other modules. Processor(s) 332 may be configured to execute modules 316, 318, 320, 322, 324, and/or 326, and/or other modules by software; hardware; firmware; some combination of software, hardware, and/or firmware; and/or other mechanisms for configuring processing capabilities on processor(s) 332. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 316, 318, 320, 322, 324, and/or 326, are illustrated in FIG. 3 as being implemented within a single processing unit, in implementations in which processor(s) 332 includes multiple processing units, one or more of modules 316, 318, 320, 322, 324, and/or 326 may be implemented remotely from the other modules. The description of the functionality provided by the different modules 316, 318, 320, 322, 324, and/or 326 described below is for illustrative purposes, and is not intended to be limiting, as any of modules 316, 318, 320, 322, 324, and/or 326 may provide more or less functionality than is described. For example, one or more of modules 316, 318, 320, 322, 324, and/or 326 may be eliminated, and some or all of its functionality may be provided by other ones of modules 316, 318, 320, 322, 324, and/or 326. As another example, processor(s) 332 may be configured to execute one or more additional modules that may perform some or all of the functionality attributed below to one of modules 316, 318, 320, 322, 324, and/or 326.

Displaying module 327 may be configured to cause the number of files of the corpus of files that match the rule to be displayed for a user. In some embodiments, displaying module 327 may cause a label for the rule to be displayed to the user (e.g., ‘rule to be revised,’ ‘high quality,’=‘low specificity,’ and the like).

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

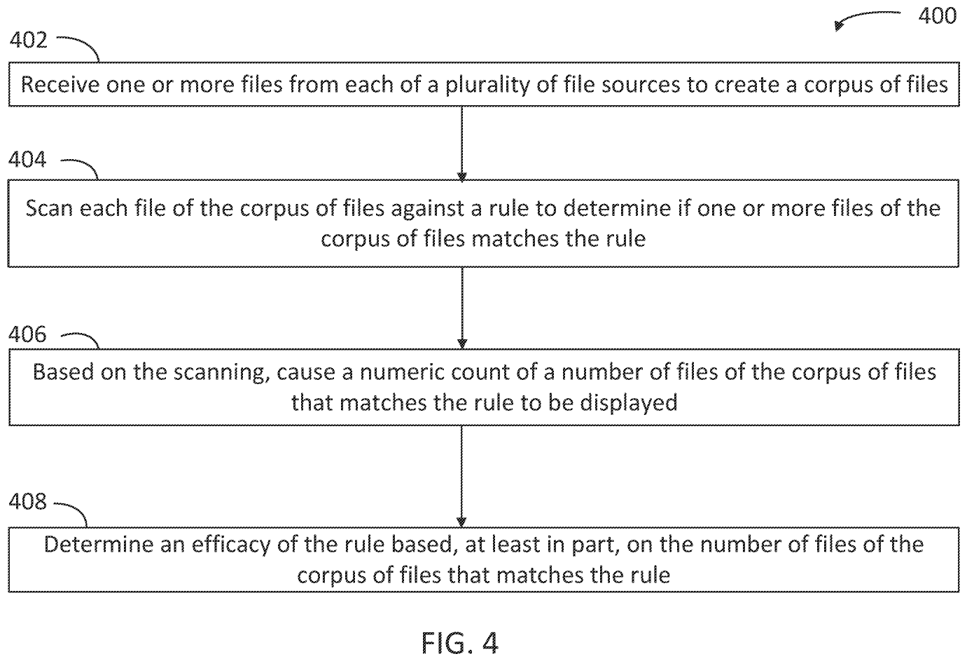

FIG. 4 illustrates an exemplary flow diagram (e.g., process 400) for evaluating files against character strings of a rule- or feature-based system for detecting malicious and/or suspicious patterns, according to certain aspects of the disclosure. For explanatory purposes, the exemplary process 400 is described herein with reference to FIGS. 1-3. Further for explanatory purposes, the steps of the exemplary process 400 are described herein as occurring in serial, or linearly. However, multiple instances of the example process 400 may occur in parallel.

At step 402, the process 400 may include receiving (e.g., through the file receiving module 316 of the system 300 of FIG. 3) a copy of at least one file from each of a plurality of file sources to create a corpus of files.

At step 404, the process 400 may include scanning (e.g., through the scanning module 318 of the system 300 of FIG. 3) each file of the corpus of files against a character string of a rule- or feature-based system for detecting malicious and/or suspicious patterns to determine if one or more files of the corpus of files matches the character string.

At step 406, the process 400 may include, based upon the scanning, causing a numeric count of a number of files of the corpus of files that matches the character string to be displayed (e.g., through the displaying module 322 of the system 300 of FIG. 3).

At step 408, the process 400 may include determining (e.g., through efficacy determining module 324 of the system 300 of FIG. 3) an efficacy of the character string based on the number of files of the corpus of files that matches the character string.

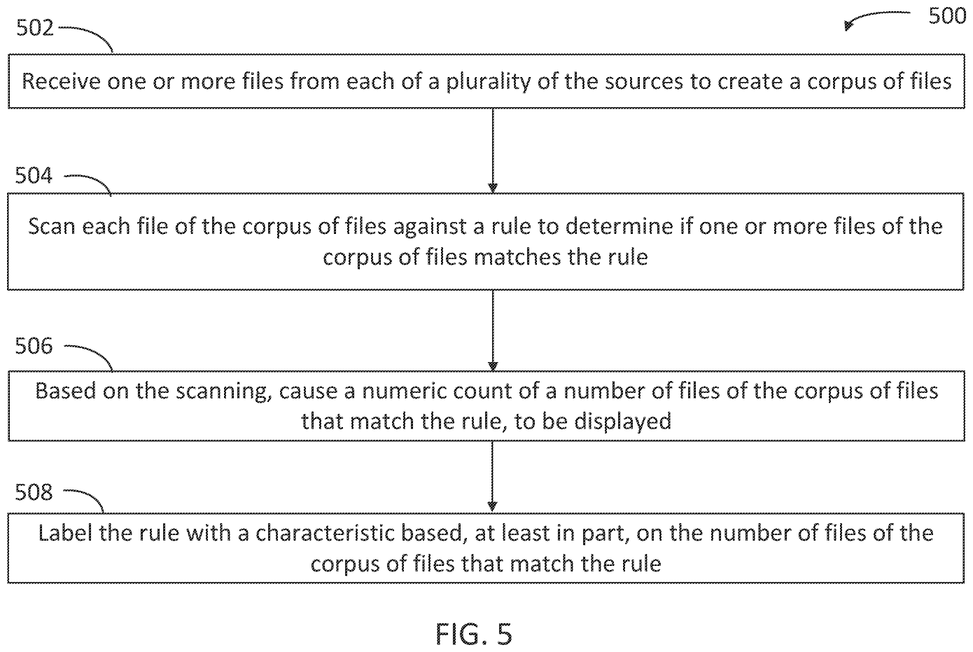

FIG. 5 illustrates an exemplary flow diagram (e.g., process 500) for evaluating files against character strings of a rule- or feature-based system for detecting malicious and/or suspicious patterns, according to certain aspects of the disclosure. For explanatory purposes, the exemplary process 500 is described herein with reference to FIGS. 1-3. Further for explanatory purposes, the steps of the exemplary process 500 are described herein as occurring in serial, or linearly. However, multiple instances of the example process 500 may occur in parallel.

At step 502, the process 500 may include receiving (e.g., through the file receiving module 316 of the system 300 of FIG. 3) a plurality of files from each of a plurality of file sources to create a corpus of files.

At step 504, the process 500 may include scanning (e.g., through scanning module 318 of the system 300 of FIG. 3) each file of the corpus of files against a character string of a rule- or feature-based system for detecting malicious and/or suspicious patterns to determine if one or more files of the corpus of files matches the character string.

At step 506, the process 500 may include, based upon the scanning, causing a numeric count of a number of files of the corpus of files that matches the character string to be displayed (e.g., through the displaying module 322 of the system 300 of FIG. 3).

At step 508, the process 500 may include labeling (e.g., through the characteristic labeling module 326 of the system 300 of FIG. 3) the character string with a characteristic based on the number of files of the corpus of files that matches the character string (e.g., the YARA rule).

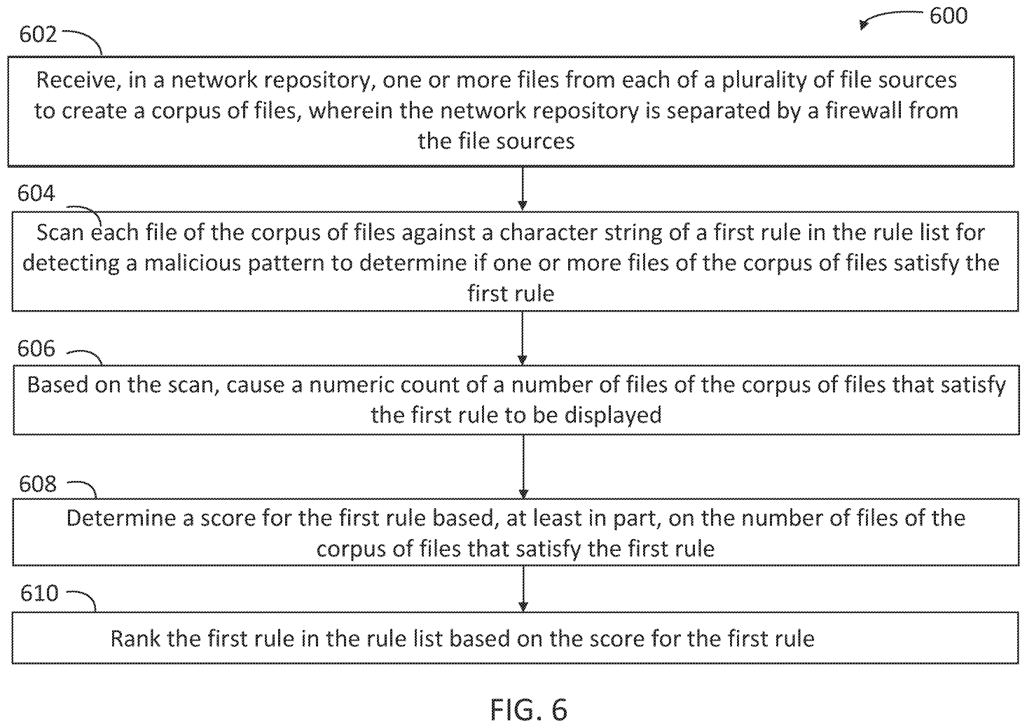

FIG. 6 illustrates another exemplary flow diagram in a method 600 for evaluating rules in a rule list for detecting malicious files in a network repository, in accordance with one or more implementations of the present disclosure.

Step 602 includes receiving, in a network repository, one or more files from each of a plurality of file sources to create a corpus of files, wherein the network repository is separated by a firewall from the file sources. In some embodiments, step 602 includes receiving one or more executable files from workstations and computers from one or more of the file sources. In some embodiments, step 602 includes receiving one or more files from multiple computational environments supported by each of the file sources.

Step 604 includes scanning each file of the corpus of files against a character string of a first rule in the rule list for detecting a malicious pattern to determine if one or more files of the corpus of files satisfy the first rule.

Step 606 includes, based on the scanning, causing a numeric count of a number of files of the corpus of files that satisfy the first rule to be displayed. In some embodiments, step 606 includes separating the numeric count based on a computing environment associated with the file. In some embodiments, step 606 includes identifying the file sources from where the files that satisfy the first rule originate as malicious nodes and building a firewall around the malicious nodes. In some embodiments, step 606 includes updating the first rule when the number of files of the corpus of files that satisfy the first rule exceeds a pre-selected threshold.

Step 608 includes determining a score for the first rule based, at least in part, on the number of files of the corpus of files that satisfy the first rule. In some embodiments, step 608 includes reducing the score when the number of files of the corpus of files that satisfy the first rule is larger than a pre-selected proportion of a total number of files of the corpus of files. In some embodiments, step 608 includes revising and upgrading the first rule when the score is lower than a pre-selected value. In some embodiments, step 608 includes scanning each file of the corpus of files against a character string of a second rule in the rule list, wherein the second rule is associated with a higher score than the first rule in the rule list. In some embodiments, step 608 includes reducing the score when the number of files of the corpus of files that satisfy the first rule is larger than a pre-selected proportion of a total number of files of the corpus of files. In some embodiments, step 608 includes revising and upgrading the first rule when the score is lower than a pre-selected value.

Step 610 includes ranking the first rule in the rule list based on the score for the first rule. In some embodiments, step 610 includes removing the first rule from the rule list when a score is lower than a selected threshold.

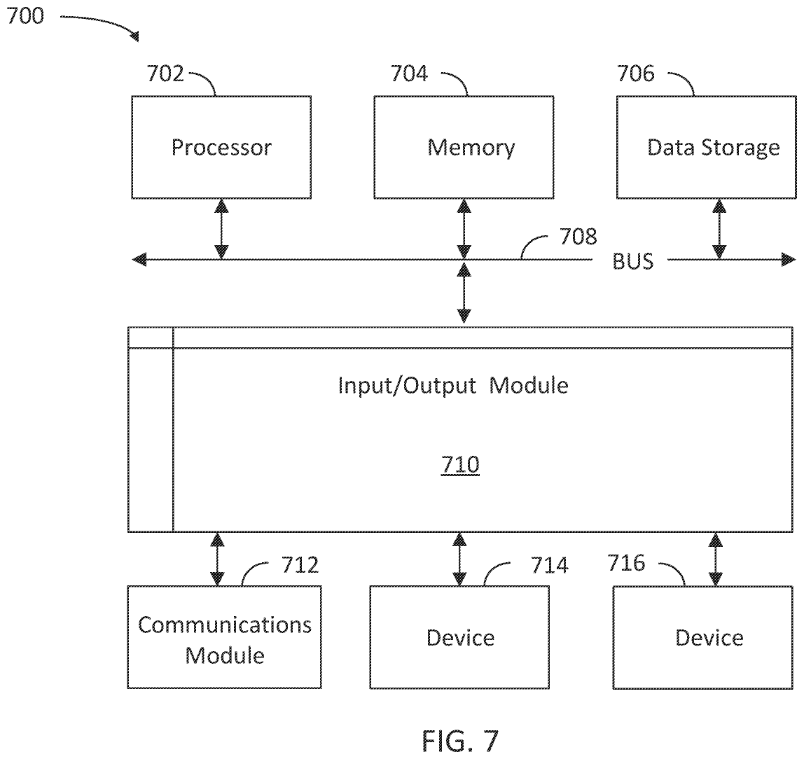

FIG. 7 illustrates a block diagram showing an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule- or feature-based languages, scripting languages, stack-based languages, synchronous languages, syntax handling languages, visual languages, Wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described gaming systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The technology is illustrated, for example, according to various aspects described below. Various examples of aspects of the subject technology are described as numbered claims (claim 1, 2, etc.) for convenience. These are provided as examples and do not limit the subject technology.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the present disclosure. For example, while operations are depicted in the drawings in a particular order, this should not be understood as requiring that such operations be performed in the particular order shown or in sequential order, or that all illustrated operations be performed to achieve desirable results. The actions recited herein can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the present disclosure.

What is claimed is:

1. A computer-implemented method for evaluating rules in a rule list for detecting malicious files in a network repository, comprising:
receiving, in a network repository, one or more files from each of a plurality of file sources to create a corpus of files, wherein the network repository is separated by a firewall from the file sources;
scanning each file of the corpus of files against a character string of a first rule in the rule list for detecting a malicious pattern to determine if one or more files of the corpus of files satisfy the first rule;
based on the scanning, causing a numeric count of a number of files of the corpus of files that satisfy the first rule to be displayed;
determining a score for the first rule based, at least in part, on the number of files of the corpus of files that satisfy the first rule; and
ranking the first rule in the rule list based on the score for the first rule.

2. The computer-implemented method of claim 1, wherein receiving one or more files comprises receiving one or more executable files from workstations and computers from one or more of the file sources.

3. The computer-implemented method of claim 1, wherein receiving one or more files comprises receiving one or more files from multiple computational environments supported by each of the file sources.

4. The computer-implemented method of claim 1, wherein causing a numeric count of the number of files comprises separating the numeric count based on a computing environment associated with the file.

5. The computer-implemented method of claim 1, further comprising removing the first rule from the rule list when a score is lower than a selected threshold.

6. The computer-implemented method of claim 1, wherein determining a score for the first rule comprises reducing the score when the number of files of the corpus of files that satisfy the first rule is larger than a pre-selected proportion of a total number of files of the corpus of files.

7. The computer-implemented method of claim 1, further comprising revising and upgrading the first rule when the score is lower than a pre-selected value.

8. The computer-implemented method of claim 1, further comprising updating the first rule when the number of files of the corpus of files that satisfy the first rule exceeds a pre-selected threshold.

9. The computer-implemented method of claim 1, further comprising scanning each file of the corpus of files against a character string of a second rule in the rule list, wherein the second rule is associated with a higher score than the first rule in the rule list.

10. The computer-implemented method of claim 1, further comprising identifying the file sources from where the files that satisfy the first rule originate as malicious nodes and building a firewall around the malicious nodes.

11. A system configured for evaluating rules in a rule list for detecting malicious files in a network repository, comprising:
one or more hardware processors configured by machine-readable instructions to:
receive, in a network repository, one or more files from each of a plurality of file sources to create a corpus of files, wherein the network repository is separated by a firewall from the file sources;
scan each file of the corpus of files against a character string of a first rule in the rule list for detecting a malicious pattern to determine if one or more files of the corpus of files satisfies the first rule;
cause a numeric count of a number of files of the corpus of files that satisfies the first rule to be displayed;
determine a score for the first rule based, at least in part, on the number of files of the corpus of files that satisfy the first rule; and
label the first rule in the rule list with the score.

12. The system of claim 11, wherein the corpus of files is divided into a plurality of file groups.

13. The system of claim 11, wherein the corpus of files is divided into a plurality of file groups that is coincident with the plurality of file sources.

14. The system of claim 11, wherein the numeric count of the number of files of the corpus of files that matches the character string is divided into a plurality of file groups and includes a numeric count for each of the plurality of file groups.

15. The system of claim 11, further comprising receiving one or more additional files into the corpus of files, scanning the one or more additional files against the character string and, upon determining that the one or more additional files matches the character string, updating the numeric count of the number of files of the corpus that matches the character string.

16. A non-transitory, computer-readable medium, storing instructions which, when executed by a processor in a computer, cause the computer to perform a method, comprising to:
receive, in a network repository, one or more files from each of a plurality of file sources to create a corpus of files, wherein the network repository is separated by a firewall from the file sources;
scan each file of the corpus of files against a character string of a first rule in a rule list for detecting a malicious pattern to determine if one or more files of the corpus of files satisfy the first rule;
cause a numeric count of a number of files of the corpus of files that satisfy the first rule to be displayed;
determine a score for the first rule based, at least in part, on the number of files of the corpus of files that satisfy the first rule;
rank the first rule in the rule list based on the score for the first rule; and
remove the first rule from the rule list when a score is lower than a selected threshold.

17. The non-transitory, computer-readable medium of claim 16, further comprising instructions to revise and upgrade the first rule when the score is lower than a pre-selected value.

18. The non-transitory, computer-readable medium of claim 16, further comprising instructions to update the first rule when the number of files of the corpus of files that satisfy the first rule exceeds a pre-selected threshold.

19. The non-transitory, computer-readable medium of claim 16, further comprising instructions to scan each file of the corpus of files against a character string of a second rule in the rule list, wherein the second rule is associated with a higher score than the first rule in the rule list.

20. The non-transitory, computer-readable medium of claim 16, further comprising instructions to identify the file sources from where the files that satisfy the first rule originate as malicious nodes and building a firewall around the malicious nodes.
